(19) United States
(12) Patent Application Publication
(10) Pub. No.: US 2025/0037608 A1
(43) Pub. Date: Jan. 30, 2025

(54) Non Toxic and Washable Slime Experience

(71) Applicant: Autumn Philip, haslet, TX (US)

(72) Inventor: Autumn Philip, haslet, TX (US)

(21) Appl. No.: 18/359,587

(22) Filed: Jul. 26, 2023

(51) Int. Cl. G09B 23/00

(52) U.S. Cl. CPC G09B 23/00

(57) ABSTRACT

The invention relates to the field of slime, particularly the field of non toxic and washable slime, and its preparation process. Further, slime compositions also contain shaving cream, instant snow, or clay.

### TECHNICAL FIELD

The invention relates to the field of slime, particularly the field of nonresidue slime for playing with ease and its preparation process.

### PROBLEM STATEMENT AND HISTORY INTERPRETATION CONSIDERATIONS INTERPRETATION CONSIDERATIONS

This section describes the technical field in detail and discusses problems encountered in the technical field. Therefore, statements in the section are not to be construed as prior art.

### DISCUSSION OF THE HISTORY OF THE PROBLEM

In the prior art, several compositions of the slime are not completely washable and stains ruin surfaces such as couches, chairs, car seats, and carpets, not leaving even after repetitive washing. Hence, the present invention relates to a washable and non-toxic slime preparation.

Additionally, improvements on pre-existing inventions, the present invention relates to being completely washable, non-toxic, and leaving zero stains on the surface.

### SUMMARY

The invention relates to the compositions of slime, particularly compositions of nonresidue slime used for playing with ease and its preparation process. The present invention relates to a process in which slime is made using the activator and glue.

The present invention also relates to a process in which slime is made using other ingredients such as instant snow, clay, and shave cream.

The technical solution adopted by the invention for the preparation of slime is characterized by the following compositions, adopted according to the nonresidue and non-stained composition of slime such as:
1. The composition of basic slime such as forming a slime with clear and transparent properties, take-home kits in the form comprising the following ingredients such as:—
   i. 100 ml of clear glue, optionally the addition of color of choice,
   ii. 13 ml activator, and;
   iii. 3-4 drops of paint.
2. The composition of slime with solid or creamy properties comprises of following ingredients:—
   i. 100 ml of white glue, optionally the addition of color of choice,
   ii. 15 ml activator, and;
   iii. 3-4 drops of paint.
3. The composition of slime with fluffy properties comprising the following ingredients such as:
   i. 60 ml white glue optionally with the addition of color of choice,
   ii. 50 ml Shave Cream,
   iii. 4-5 drops of paint, and;
   iv. 10 ml Activator.
4. The composition of slime with buttery properties comprising the following ingredients such as:
   i. 100 ml white glue optionally with the addition of color of choice,
   ii. 1.5 oz modeling clay,
   iii. 3-4 drops of paint, and;
   iv. 10 ml Activator.
5. The composition of slime with cloudy properties comprising the following ingredients such as:
   i. 60 ml white or clear glue optionally with the addition of color of choice,
   ii. 40 ml shave cream,
   iii. 3-4 Drops of paint,
   iv. 13 ml activator, and;
   v. 2 teaspoons of instant snow.

The present invention relates to a glue composition and the process of making the slime. In one of the embodiments, the present invention relates to a clear glue composition and the process of making the slime comprising the following steps such as:—
Step 1, is initiated by adding 5 ml of activator to glue.
Step 2, is initiated by continuously stirring the ingredients of step 1, for a time period of 30 to 45 seconds.
Step 3, involves adding 2 ml of activator, at a time until a desired consistency is achieved.

In one of the embodiments, the present invention relates to a white glue composition and the process of making the slime comprising the following steps such as:—
i. Step 1, is initiated by adding 3 ml of activator (water or boric acid or non-iodized salt or nontoxic borax) are added to glue,
ii. Step 2, is the continuous stirring of the composition, by optionally adding 2-3 ml until a desired consistency of the composition of thick paste is achieved.
iii. In Step 3, the sticky composition formed in the above step is poured on the table and blended with hand to form a uniform slime.
iv. In Step 4, to the slime formed in Step 3, vaseline is added and the slime is ready for use.
v. Step 5, for forming colored slime the choice of washable gel paint color is added.

### DESCRIPTION OF AN EXEMPLARY PREFERRED EMBODIMENT

### Interpretation Considerations

While reading this section (Description of an Exemplary Preferred Embodiment, which describes the exemplary embodiment of the best mode of the invention, hereinafter referred to as “exemplary embodiment”), one should consider the exemplary embodiment as the best mode for practicing the invention during filing of the patent in accordance with the inventor's belief. As a person with ordinary skills in the art may recognize substantially equivalent structures or substantially equivalent acts to achieve the same results in the same manner, or in a dissimilar manner, the exemplary embodiment should not be interpreted as limiting the invention to one embodiment.

The discussion of a species (or a specific item) invokes the genus (the class of items) to which the species belongs as well as related species in this genus. Similarly, the recitation of a genus invokes the species known in the art. Furthermore, as technology develops, numerous additional alternatives to achieve an aspect of the invention may arise. Such advances are incorporated within their respective genus and should be recognized as being functionally equivalent or structurally equivalent to the aspect shown or described. Unless, explicitly stated otherwise, conjunctive words (such as “or”, “and”, “including”, or “comprising”) should be interpreted in the inclusive and not the exclusive sense.

### Definitions

The following is the list of definitions for the terms used:
i. Slime is defined as a thick and slippery liquid substance and has a property of a non-newtonian fluid. This simply means the substance does not follow Newton's law of viscosity. Depending on “stress” or how the substance is manipulated it will change the viscosity of the matter, meaning it will appear more solid or liquid depending on the environment. Since we know what slime is and some of its properties, let's break down the ingredients and how the chemicals react to make slime.
ii. Glue: The main ingredient in slime is Glue. Glue is made from PVA (polyvinyl acetate). PVA is a long string of vinyl acetate that when dried locks into place; think of putting glue on your hand and waiting for it to dry. PVA alone however does not make slime. We still need to change the chemical structure just a bit to get the flowing liquid more like a putty substance.
iii. Borate ions: Borate ions are made from oxygen, 4 hydrogens, and 1 boron molecule. Borate are required to create a cross-link with PVA in order to make slime. Borate ions can be found in many items such as borax, contact solution, table salt, laundry detergent, etc. When adding Borate ions to PVA it creates a cross link and locks the molecules together to create a material with new properties, slime.

### Activator:

35 ml borax
45 ml baking soda
8 oz contact solution
128 oz water.

In one of the aspects, the composition range of ingredients combined for slime formulation should be in the range of 200 ml.

In one of the embodiments, the activator ranges in the slime composition constituents for forming uniform consistency, in the range of NLT to NMT 10-18 ml.

TABLE 1, below provides the slime formulation in the following ranges such as:

TABLE 1

| S No. | Component | Clear slime | White slime | Fluffy slime | Butter slime | Cloud slime |
|---|---|---|---|---|---|---|
| 1. | Clear or | NLT 20 ml to | NLT 20 ml to | NLT 20 ml to | NLT 20 ml to | NLT 20 ml to |
| | white glue | NMT 100 ml | NMT 100 ml | NMT 100 ml | NMT 100 ml | NMT 100 ml |
| 2. | Activator | NLT 8 ml to | NLT 8 ml to | NLT 8 ml to | NLT 8 ml to | NLT 8 ml to |
| | | NMT 50 ml | NMT 50 ml | NMT 50 ml | NMT 50 ml | NMT 50 ml |
| 3. | Shaving | — | — | NLT 30 ml to | — | — |
| | cream | | | NMT 50 ml | | |
| 4. | Modeling | — | — | — | NLT 1.0 oz | — |
| | clay | | | | to 20 oz | |
| 5. | Instant | — | — | — | — | NLT 20 ml to |
| | snow | | | | | NMT 100 ml |
| 6. | Paint | NLT 8 ml to | NLT 8 ml to | NLT 8 ml to | NLT 8 ml to | NLT 8 ml to |
| | | NMT 50 ml | NMT 50 ml | NMT 50 ml | NMT 50 ml | NMT 50 ml |

1. Our process is specific to Slime Land inc and produces a washable and non-toxic slime. The process includes educational aspects including learning the difference between solid and transparent, primary colors and how to use them, liquid vs solid, and the non-newtonian law. Our formula base is the same for each slime but some recipes add other decorative ingredients to change the texture or appearance but will still remain washable. The basic process we have created goes as follows:
1. Select glue of choice and add to beaker
2. Select color from the three primary colors and mix.
3. Add in Activator slowly while stirring (according to specific recipe)
4. Stir until the thickness is formed and empty onto the table.
5. Mix and knead slime until it is no longer sticky.
6. Add toppings and decorations of choice.
Example 1
Clear Glue Composition
In one of the present invention relates to a clear glue composition and the process of making the slime comprising the following steps such as:
Step 1, is initiated by adding 100 ml of clear glue to a beaker
Step 2, is initiated by adding washable paint of choice
Step 3, is initiated by continuously stirring the ingredients of step 1 and two, for a time period of 30 to 45 seconds.
Step 4, involves adding 5 ml of activator, and mixing at the same time.
Step 5, is adding 2 ml of activator at a time until a desired consistency is achieved.
Step 6, is where the slime is emptied onto the table and mixed vigorously with hands until the mixture is desired texture.
Step 7, is initiated by adding toppings such as but not limited to glitter, foam beads, and charms.
Example 2
White Glue Composition
In one of the embodiments, the present invention relates to a white glue composition and the process of making the slime comprising the following steps such as:—
Step 1, is initiated by adding 100 ml of white glue to a beaker
Step 2, is initiated by adding washable paint of choice
Step 3, is initiated by continuously stirring the ingredients of step 1 and two, for a time period of 30 to 45 seconds.
Step 4, involves adding 5 ml of activator, and mixing at the same time.
Step 5, is adding 3 mL of activator at a time until a desired consistency is achieved.
Step 6, is where the slime is emptied onto the table and mixed vigorously with hands until the mixture is desired texture.
Step 7, is initiated by adding toppings such as but not limited to glitter, foam beads, and charms.
Example 3
“Butter” Slime Composition
In one of the embodiments, the non-residue (“butter texture”) slime compositions explained the steps below:
Step 1, is initiated by adding 100 ml of clear or white glue to a beaker
Step 2, is initiated by adding washable paint of choice
Step 3, is initiated by continuously stirring the ingredients of step 1 and two, for a time period of 30 to 45 seconds.
Step 4, involves adding 5 ml of activator, and mixing at the same time.
Step 5, is adding 2 ml of activator at a time until a desired consistency is achieved.
Step 6, is where the slime is emptied onto the table and mixed vigorously with hands until the mixture is the desired texture (slime should be a little sticky before the next step).
Step 7, is initiated by adding 1 oz of clay to slime and kneading together.
Step 8, is the final step adding toppings such as but not limited to glitter, foam beads, and charms. The resulting non-residue slime composition is ready for use.
